(19) United States
(12) Patent Application Publication
(10) Pub. No.: US 2004/0128457 A1
(43) Pub. Date: Jul. 1, 2004

(54) Disk drive with copy function

(75) Inventor: Yuuko Maki, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/623,648

(22) Filed: Jul. 22, 2003

(30) Foreign Application Priority Data
Aug. 30, 2002 (JP) 2002-253069

(51) Int. Cl. G06F 12/16

(52) U.S. Cl. 711/162; 711/114

(57) ABSTRACT

A disk drive is disclosed which has a copying function to copy data which is recorded on its disk medium onto a copying destination disk drive as an external device. Upon receipt of a copying operation command from an operated switch, a communication link is established to the copying destination disk drive. The disk drive transfers read-out data from the disk medium as well as a write command to the copying destination disk drive.

### CROSS-REFERENCE TO RELATED APPLICATIONS

This application is based upon and claims the benefit of priority from the prior Japanese Patent Application No. 2002-253069, filed Aug. 30, 2002, the entire contents of which are incorporated herein by reference.

### BACKGROUND OF THE INVENTION

1. Field of the Invention

The present invention relates generally to the field of disk drives and, in particular, to a disk drive having the function to copy data which is recorded on a disk medium onto an external device.

2. Description of the Related Art

In general, a disk drive typical of a hard disk drive (HDD) uses a disk medium as a recording medium and allows data to be recorded on the disk medium and the recorded data to be reproduced from the disk medium.

In recent years, the disk drive has been used also as a digital recording device not only in personal computers, etc., for handling computer data, but also in cellular telephones, etc., for handling communication data and in other devices for handling AV (audio-visual) data, etc.

Under such circumstances, a growing demand has arisen for copying the data which is recorded on a disk medium of one disk drive onto the same kind of an HDD or a different kind of optical disk drive such as a CD-RAM.

In a disk drive such as an HDD, when the data recorded on an internal disk medium is to be copied onto an external disk drive, it has been necessary to control a host system such as a PC. Stated in more detail, it has been necessary to perform a copying operation through an OS of the host system.

As set out above, however, a small-sized disk drive is used not only as an external device of the PC but also as various kinds of digital recording devices and it is desirable to independently realize the copying function irrespective of the host system.

As the prior art technique, a device has been proposed by which a still image can be transferred from a built-in disk drive of a system to an external disk drive (See JPN PAT APPLN KOKAI PUBLICATION NO. 11-259961). In the prior art technique disclosed, the copying operation from the built-in drive to the external drive is achieved under control of the host system. As another prior art technique, a host system has also been proposed under which a disk recorder connected to SCSI bus functions as an initiator and recorded data is transferred to the hard disk device (See JPN PAT APPLN KOKAI PUBLICATION NO. 2000-347990). Even in this prior art technique, however, a CPU of a host system is used under which the disk recorder functions as an initiator and a copying function is achieved under control of the host system.

### BRIEF SUMMARY OF THE INVENTION

In accordance with one embodiment of the present invention, there is provided a disk drive including facilities to copy data read from a disk medium to an external device.

The disk drive comprises a head configured to read recorded data from a disk medium; a read channel configured to reproduce data from the read signal which is output from the head; a command unit configured to instruct a copying operation for allowing the data which is reproduced by the read channel to be transferred to an external device; an interface unit configured to effect a data transfer relative to the external unit; and a control unit configured to, in accordance with the copying operation instructed by the command unit, perform the copying operation while allowing the reproduced data to be transferred to the external device through the interface unit.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block circuit showing a structure of a disk drive relating to an embodiment of the present invention;

FIG. 2 is a block circuit for explaining a copying operation between disk drives relating to the present embodiment;

FIG. 3 shows a flowchart for explaining a process of a copying operation relating to the present embodiment;

FIG. 4 is a flowchart for explaining an operation of a copying destination drive relating to the present embodiment;

FIG. 5 is a view showing an external appearance of a disk drive relating to the present embodiment;

FIG. 6 is an external view showing a state of a connection between a copying source disk and the copying destination disk in the present embodiment;

FIGS. 7A and 7B, each, are a view for explaining a transmit sequence based on the serial ATA Interface Standard in the present embodiment;

FIG. 8 is a view for explaining a structure of register groups based on the serial ATA Interface Standard in conjunction with the present embodiment; and

FIG. 9 is a block view relating to a variant of the present embodiment.

### DETAILED DESCRIPTION OF THE INVENTION

An embodiment of the present invention will be explained below by referring to the drawing.

(Structure of Disk Drive)

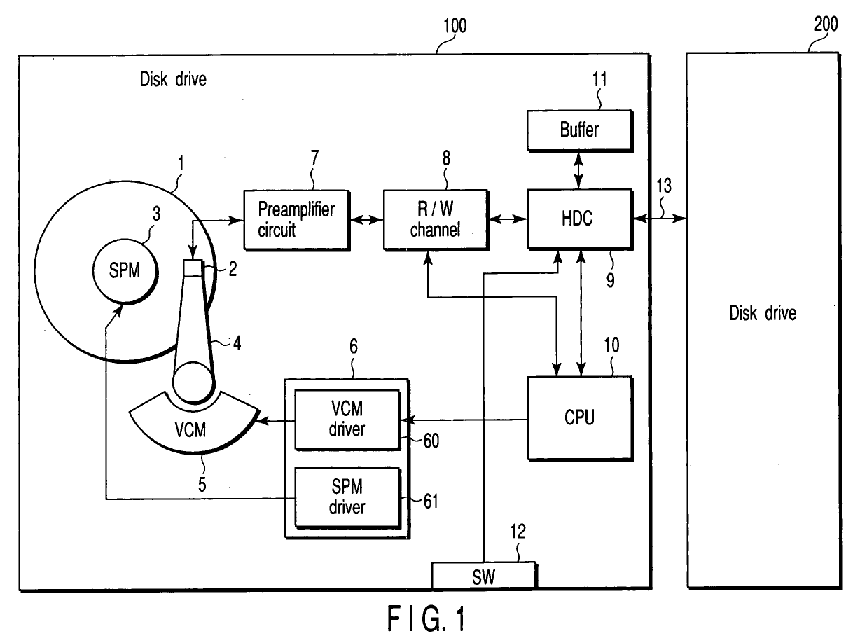

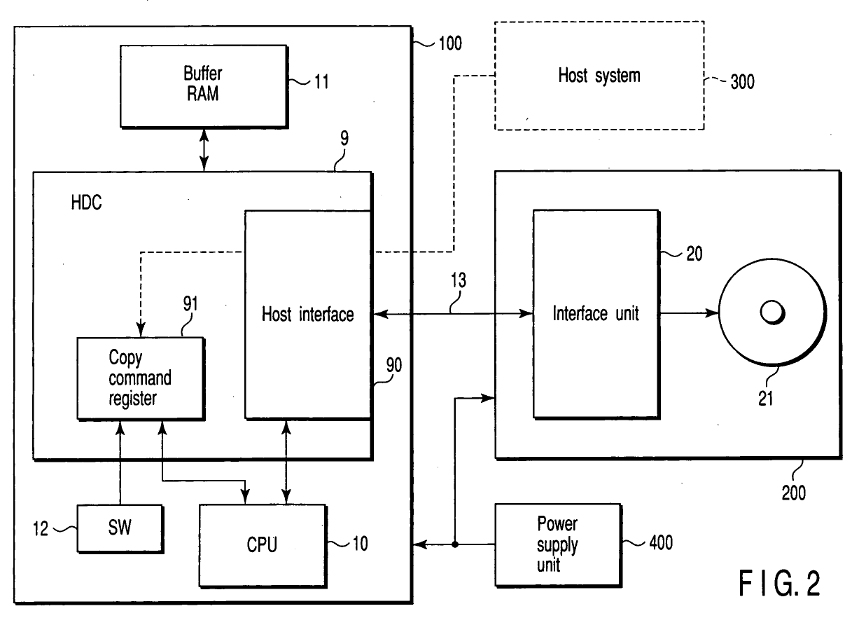

FIG. 1 is a block diagram showing a structure of a disk drive 100 relating to the present embodiment. FIG. 2 is a block diagram for explaining a copying operation between the present drive 100 assumed as the structure of a copying source disk drive and a disk drive 200 serving as a copying destination drive.

The present drive 100 is comprised of an HDD including, as shown in FIG. 1, a disk medium 1, a head 2, a disk controller (HDC) 9, a CPU (microprocessor) 10 and a switch 12.

The disk medium 1 is rotated by a spindle motor (SPM) 3 to allow data which is written by the head 2 to be recorded thereon. The head 2 includes a write head for writing the data to the disk medium 1 and a read head for reading the data from the disk medium 1. The head 2 is mounted on an actuator 4 and moved in a radial direction over the disk medium. The actuator 4 is driven by a voice coil motor (VCM) 5. A motor driver IC 6 includes a VCM driver 60 and SPM driver 61, these drivers driving a VCM 5 and SPM 3 under control of the CPU 10.

The HDC 9 includes a host interface 90 between the present drive 100 and an external device and, under control, mainly effects the transfer of the read/write data (see FIG. 2). The HDC 9 temporarily stores the read/write data in a buffer RAM 11 and adjusts the data transfer speed. Further, the HDC 9 effects data transfer relative to the disk medium 1 through a preamplifier circuit 7 and read/write channel 8.

The preamplifier circuit 7 has a read amplifier for amplifying a read signal read out by the read head of the head 2. Further, the preamplifier circuit 7 has a write amplifier for converting a write signal which is sent from the read/write channel 8 to a current and supplying the current to the write amplifier.

The read/write channel 8 is comprised of a signal processing IC generally separated into a read channel and a write channel. The read channel processes a read signal which is transferred through the read head and read amplifier and reproduces data which is recorded on the disk medium 1. The write channel performs processing, such as encode processing, on the write data transferred from a host system 300 or another disk drive 200 and sends a result to the write amplifier. The write head writes the data onto the disk medium 1 in accordance with a write current which is outputted from the write amplifier.

The CPU 10 serves as a main control device in the drive 100 and has the function to control a normal read/write operation and copying operation relating to the present embodiment. The CPU 10 gains access to various kinds of register groups in the HDC 9 and performs a normal read/write command and has the function to issue a write command necessary to the copying operation relating to the present embodiment.

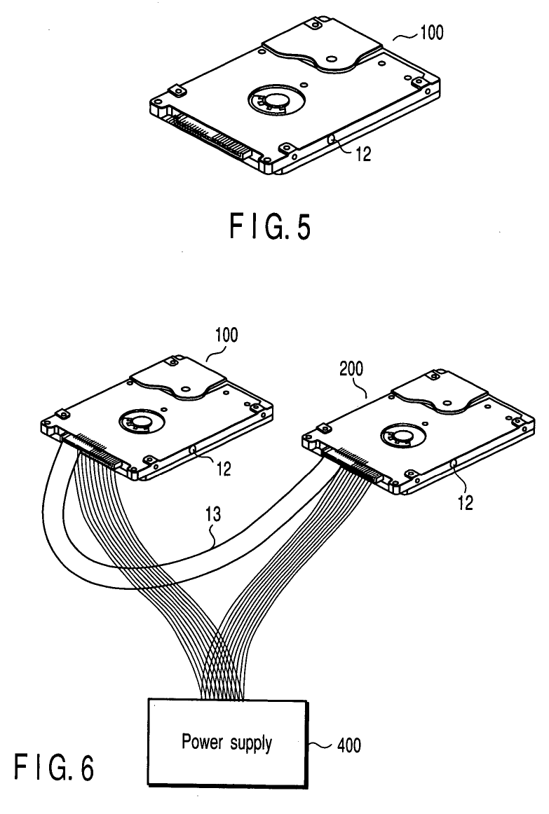

Further, the present drive 100 serves as a copying source drive and has a switch 12 for instructing a copying operation by the user. That is, the switch 12 corresponds to an input unit for inputting information (flag information) for instructing the copying operation. The switch 12 is provided, as shown in FIG. 5 for example, on a side portion or a back portion of a drive housing. The switch 12 is so provided as to retract inside the housing and protected from being readily contacted from an outside.

As shown in FIG. 2, the HDC 9 of the present drive 100 has a copying command register 91 for holding information (0/1 flag information) which is input from the switch 12 to allow a copying operation to be instructed. Upon receipt of an ON operation of the switch 12 for example, the copying command register 91 sets the flag information (here, a logical 1) for instructing the copying operation.

The CPU 10 refers to the copying command register 91 and, when the flag information is set, receives a copying operation command. It is to be noted that, in accordance with the copying command transmitted from the host system 300, the HDC 9 allows the flag information to be set to the copying command register 91.

Here, the HDC 9 has a host interface 90 based on, for example, the serial ATA Interface Standard. The present drive 100 is connected to an interface unit 20 of the copying destination disk drive 200 through an interface cable 13 based on the serial ATA Interface Standard.

The copying destination drive 200 is comprised of an HDD the same type as the present drive 100 or a normal system HDD excepting the switch 12 and copying command register 91. Thus, the interface unit 20 includes, for example, a host interface based on the serial ATA Interface Standard. The copying destination drive 200 has a disk medium 21 the same memory capacity and the same format as those of the disk medium 1 of the present drive 100. Also, the copying destination drive 200 includes heads necessary to the recording or reproducing of data relative to the disk medium 21 as well as various kinds of constituent elements such as a read/write channel and CPU.

Further, according to the present embodiment, use can be made of a dedicated power supply unit 400 configured to supply operation power to the present drive 100 and copying destination drive 200. That is, the respective drives 100 and 200, being used as an external memory device for the host system 300, have their power supply received from the host system 300 and, in the case of performing an independent copying operation, the power supply is received from the dedicated power supply unit 400.

(Copying Operation)

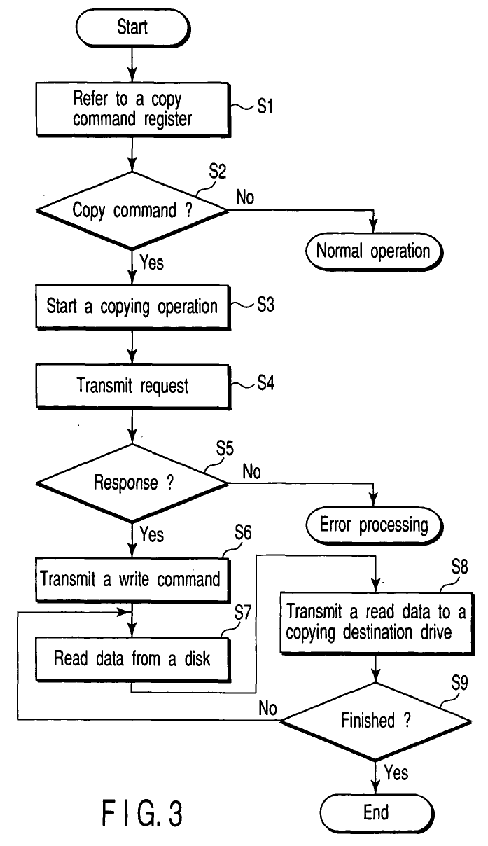

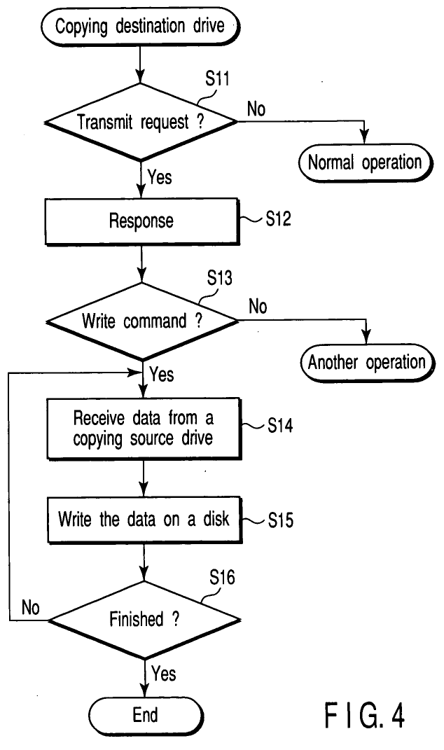

With reference to not only FIGS. 1 and 2 but also FIGS. 3 and 4, the copying operation will be explained below in connection with the flowcharts of FIGS. 3 and 4.

First, as shown in FIG. 6, the present drive (copying source disk drive) 100 and copying destination disk drive 200 are connected together by the cable 13 based on the serial ATA Interface Standard for example. The power supply is effected to the respective drives 100 and 200 by means of the dedicated power supply unit 400.

In the present drive 100, as shown in FIG. 3, the CPU 10 gains access to the copying command register 91 of the HDC 9 and it determines whether or not any flag information (corresponding to a copy command) for instructing the copying operation is set (steps S1, S2). In the present drive 100, as an initial operation at a power ON time, the CPU 10 always gains access to the copying command register 91 and it determines whether the copying operation or normal read/write operation is performed.

Here, in order to allow all data which is recorded on the disk medium 1 of the present drive 100 to be coped on another copying destination drive 200, the switch 12 is turned ON by the user. Thus, the flag information corresponding to the copying command is set to the copying command register 91 (YES in step S2).

The CPU 10 starts not a normal read/write operation but a copying operation for transferring all the recording data of the disk medium 1 to the copying destination disk drive 200 (step S3). The CPU 10 makes a transmit request for establishing a communication link relating to the data transfer to the copying destination disk drive 200 via the host interface 90 (step S4).

The copying destination disk drive 200 performs a response to the transmit request because it has the interface unit 20 based on the same interface standard as that of the present drive 100. Here, where the copying destination disk drive 200 uses the interface unit 20 of the interface standard different from that of the present drive 100, there is no predetermined response to the transmit request and the CPU 10 handles this as not being copiable and makes a shift to error processing (NO in step S5). As the error processing, error history information relating to the copying operation is recorded, for example, on the disk medium 1 at a system area. This error history information can be read out from the host system 300 when the present drive 100 is connected to the host system 300.

Upon receipt from a response from the copying destination disk drive 200, the host interface 90 of the present drive 100 establishes a communication link and the data transfer is made from drive to drive (the copying target data transfer).

The CPU 10 generates a write command via the host interface 90 and transmits it to the copying destination drive 200 (YES in step S5, step S6). Here, the write command is the same as a command associated with a normal write operation and contains the address and transfer amount (data sector number) of transferring record data.

Then the CPU 10 reads recorded data out of the disk medium 1 through the head 2 and reproduces the recorded data through the preamplifier circuit 7 and read/write channel 8 (step S7).

The CPU 10 transfers the reproduced data (read data) through the host interface 90 to the copying destination disk drive 200 (step S8). The CPU 10 reads out all the data on the disk medium 1 and repeats the copying operations until the data is transferred to the copying destination disk drive 200 (step S9).

In the copying destination disk drive 200, on the other hand, as shown in FIG. 4, upon receipt of the transmit request from the copying source drive 100, the interface unit 20 sends back a response to the transmit request (step S11, S12).

When, after the performing of an initial operation at a power ON time, the copying destination disk drive 200 receives a normal read/write command, not a transfer request, from the host system 300, it performs a normal read/write operation.

The interface unit 20 receives a write command from the copying source drive 100 and then receives subsequently transferred data. The copying destination drive 200 performs a write operation for writing data on a disk medium 21 (YES in step S13, step S14, step S15). When all the data transferred from the copying source drive 100 is recorded on the disk medium 21, the copying operation is finished (YES in step S16).

According to the disk drive 100 of the present embodiment, if only the switch 12 is operated to supply power from the dedicated power supply unit 400, the recorded data can be transferred from the copying source drive 100 to the copying destination drive 200. In the copying destination drive 200, the transferred recording data is recorded onto the disk medium 21 by the normal write operation. Thus, all the recorded data on the copying source drive 100 can be copied to the copying destination drive 200.

In this case, in the present embodiment, the copying operation can be realized by independently using the copying source drive and copying destination drive 200 without the participation of the host system.

As an application example of the present embodiment, image data taken by a digital camera for instance is reserved with the use of the copying source drive 100. By separating the copying source drive 100 from the digital camera (one kind of host system 300) and independently connecting it to another copying destination drive 200 it is possible to copy the reserved image data to the copying destination drive 200.

(Practical Form of Host Interface)

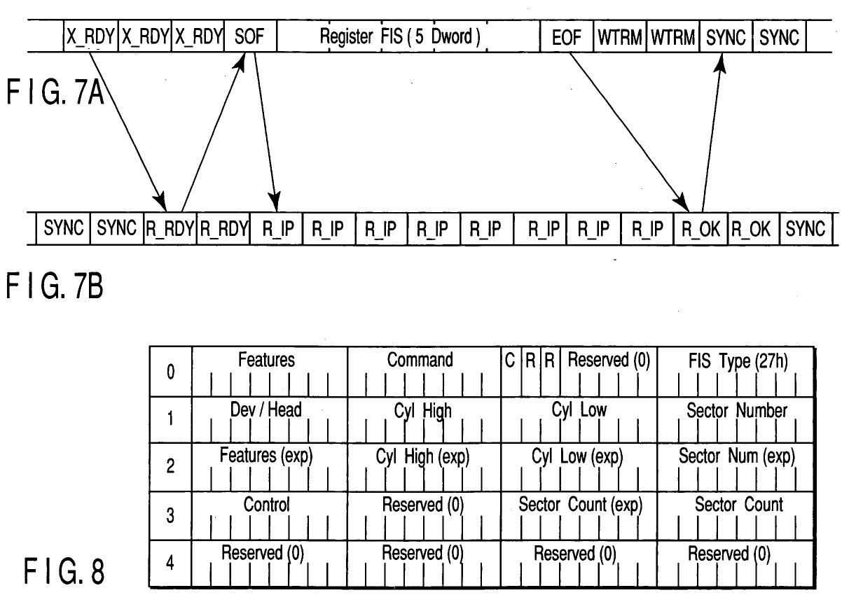

As set out above, the drive 100 of the present embodiment is connected to the copying destination drive 200, for example, by the cable 13 based on the serial ATA Interface Standard and performs data transfer. With reference to FIGS. 7A, 7B and 8, an explanation will be made in more detail below about the method for transferring data from drive to drive based on the serial ATA Interface Standard.

As shown in FIG. 6, the respective drives 100 and 200 are connected together by means of the cable 13 based on the serial ATA Interface Standard. In the copying source drive 100, the host interface 90 prepares a write command (containing an address and transfer sector number) in a form based on the serial ATA Interface Standard in accordance with the flag information corresponding to a copy command by the operation of the switch 12 and transfers it to the copying destination drive 200.

The copying destination drive 200 receives the write command and subsequent data through the interface unit 20 based on the serial ATA Interface Standard and writes (copies) these on the disk medium 21.

In the serial ATA Interface Standard, as in the case of the host system 300, the disk drive 100 (or 200) on the device side can issue a request (transmit request) for a start of data transfer. In the serial ATA Interface Standard, as shown in FIG. 6, respective standards of a signal interface connector connected by the cable 13 and power supply connector for the connection of the power supply cable are set.

FIGS. 7A and 7B each are views showing one practical form of a transmit sequence when data transfer is effected under the serial ATA Interface Standard. FIG. 8 is a view showing an array of register groups called the FIS (Frame Information Structures) under this Standard. The host interface 90 of the present drive 100 transfers a write command and recorded data to the copying destination drive 200 with the use of the FIS register groups.

FIG. 7A shows a sequence of the copying source drive 100 and FIG. 7B shows a sequence of the copying destination drive 200. Here, the transmit sequence under the Standard is a Primitive level sequence. “Primitive” denotes a minimal unit to be transferred and is comprised of data bit number of the Dword, noting that the Dword means 32 bits.

As shown in FIG. 7A, the data source drive 100 transmit X_RDY Primitive as a transmit request. As shown in FIG. 7B, the copying destination drive 200 sends back R_RDY Primitive as a response. Upon receipt of the response (R_RDY Primitive), the copying source drive 100 transmits a Frame (here, Frame: a write command) corresponding to 5 Dwords in the FIS register group. It is to be noted that the transmit frame contains FIS contents with SOF Primitive as a start and EOF Primitive as an end.

Here, the format of the write command as a transit request is comprised of FIS register groups as shown in FIG. 8. That is, a data transfer destination address for example is set by Cyl Low register and Cyl High register for setting a cylinder address on the disk medium 1. Further, the sector transfer number is set to a Sector Number register for setting a data selector number. The method for setting these register groups is applied under the serial ATA Standard.

Then, the copying source drive 100 transmits the recorded data subsequent to the write command at a frame corresponding to 5 Dwords. Stated in more detail, the copying source drive 100 transmits recorded data at a sector unit, noting that, here, a data amount corresponding to one sector corresponds to 128 Dwords. Thus, the copying source drive 100 performs data transfer at 128-times transmit sequence in the case of transmitting the recorded data of 512 bytes corresponding to one sector.

(Another Embodiment)

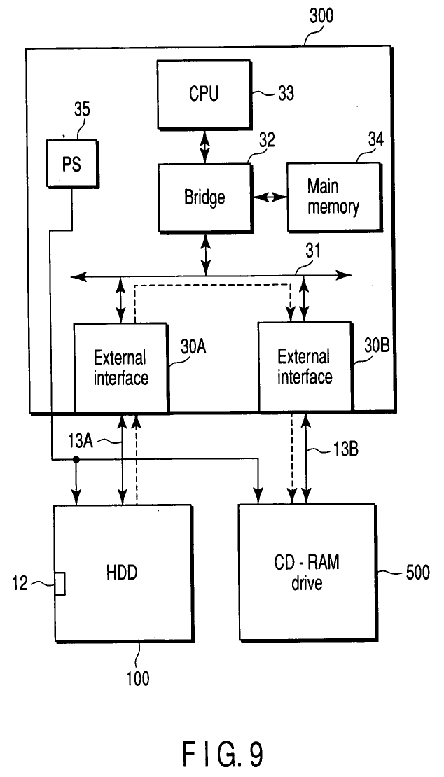

FIG. 9 is a block diagram showing another embodiment.

The present variant shows a structure for realizing a copying operation between those disk drives connected to external interfaces 30A and 30B (under the serial ATA Interface Standard) in a host system 300 such as a PC.

As a copying source drive 100, use is made of an HDD the same as in the embodiment above and that, as the copying destination drive, use is made of the CD-RAM 500. The CD-RAM drive 500 is one kind of rewritable optical disk drive with a rewritable optical disk (compact disk) used as a recording medium.

The host system 300 has a PCI bus 31 as an internal bus 31 and, through the bus 31, a bridge 32 is connected to the external interfaces 30A, 30B. To the bridge 32, a CPU 33, main memory 34, etc., in the host system 300 are connected.

The copying source drive 100 and copying destination drive 500 are connected to the external interfaces 30A and 30B, as set out above, respectively through cables 13A and 13B. It is to be noted that an internal power supply unit 35 in the host system 300 supplies power to the copying source drive 100 and copying destination drive 500.

In this structure, simple by the operation of a switch 12 in the copying source drive 100, all data recorded in a disk medium of the copying source drive 100 can be transferred to the copying destination drive 500 and copied to the drive 500. Even in the present embodiment, the copying operation is basically the same as that in the above embodiment but a write command and data from the copying source drive 100 are transferred to the copying destination drive 500 through the cable 13B, external interface 30A, PCI bus 31 and external interface 30B.

In the copying destination drive 500, the recorded data thus transferred is recorded onto a rewritable optical disk (recording medium) in accordance with the write command based on the serial ATA Interface Standard. Here, in the copying destination drive 500, a memory capacity of the optical disk (memory medium) is equal to, and greater than, that of the copying source drive 100.

It is needless to say that this embodiment can be applied to the case where the CD-RAM drive 500 serves as a copying source drive and the HDD 100 serves as a copying destination drive.

According to the present embodiment and another embodiment, it is possible to readily realize a copying operation from disk drive to disk drive. That is, when a copying operation is instructed through a switch means for example in the present disk drive, a communication link is established to the copying destination disk drive to allow recorded data to be transferred as a copying target. As in the case of a normal write operation, the copying destination disk drive allows the recorded data which is transferred from the present drive (copying source disk drive) to be written onto the corresponding disk medium. Thus, it is possible to realize the copying function through a transfer of the recorded data from disk drive to disk drive.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive comprising:
a head configured to read recorded data from a disk medium;
a read channel configured to reproduce data from a read signal which is output from the head,
a command unit configured to instruct a copying operation for allowing the data which is reproduced by the read channel to be transferred to an external device;
an interface unit configured to effect a data transfer relative to the external device; and
a control unit configured to, in accordance with a copying operation instructed by the command unit, perform the copying operation while allowing the reproduced data to be transferred to the external device through the interface unit.

2. A disk drive according to claim 1, wherein the command unit includes a register configured to hold copying operation instructing information.

3. A disk drive according to claim 1, wherein the command unit includes a register configured to hold copying operation instructing information and an input device configured to input the information.

4. A disk drive according to claim 1, wherein the control unit performs a normal read operation for reading data from the disk medium or a normal write operation for writing data onto the disk medium and, when the copying operation is instructed by the command unit, performs the copying operation in preference to the normal read operation or write operation.

5. A disk drive according to claim 1, wherein the command unit includes a register configured to hold the copying operation instructing information and, by referring to the register at a predetermined timing, the control unit performs the copying operation in accordance with the information set by the register.

6. A disk drive according to claim 1, wherein, when the copying operation is performed, the control unit issues a command for allowing the reproduced data to be written into a recording medium in the external device and transfers the reproduced data to the external device through the interface unit.

7. A disk drive according to claim 1, wherein, before performing the copying operation, the control unit makes a data transmit request for the external device via the interface unit and performs the copying operation upon receipt of a response to the transmit request which comes form the external device.

8. A disk drive according to claim 1, wherein the interface unit includes a register configured to hold the copying operation instructing information and the register holds the information input from an input unit in the command unit and is accessed from the control unit.

9. A disk drive according to claim 1, wherein, in a copying source disk drive connected to an external interface unit of a host system and connected via on internal interface signal line of the host system to a copying destination disk drive, the interface unit is connected to the external interface unit in accordance with a copying operation by the control unit to transmit the reproduced data to the copying destination drive.

10. A method of transferring data read from a disk medium to an external device in a disk drive, the method comprising:
receiving a copying operation command;
conducting a communication with the external device as a copying destination device in accordance with the copying operation command; and
transferring data which is read out from the disk medium to the external device when a communication link is established to the external device.

11. A method according to claim 10, wherein the disk drive has an input unit configured to input the copying operation instructing information and a register configured to hold that information, further comprising when the information is set to the register, receiving the copying operation command.

12. A method according to claim 10, wherein the conducting comprises making a transmit request for the external device, and which further comprises establishing the communication link to the external device in accordance with a response from the external device.

13. A method according to claim 10, further comprising transmitting a command for instructing the writing of the data to a recording medium in the external device, when the read-out data is transferred to the external device connected as a copying destination.

14. A method according to claim 10, wherein the transferring comprises transferring data from the disk medium to another disk drive as the external device via an interface unit for connecting with the external device based on a predetermined interface standard.

15. A method according to claim 14, further comprising, when the data read from the disk medium is to be transferred in accordance with the copying operation command, transferring a command for instructing the writing of the data on a disk medium included in the copying destination disk drive.
